(19) United States
(12) Patent Application Publication
(10) Pub. No.: US 2019/0295115 A1
(43) Pub. Date: Sep. 26, 2019

(54) METHOD AND SYSTEM FOR VOUCHER REDEMPTION

(71) Applicant: Mastercard International Incorporated, Purchase, NY (US)

(72) Inventors: Piyush Sharma, Pune (IN); Ravinder Wadhwa, Pune (IN); Navneet Jain, Pune (IN)

(73) Assignee: Mastercard International Incorporated, Purchase, NY (US)

(21) Appl. No.: 16/298,085

(22) Filed: Mar. 11, 2019

(30) Foreign Application Priority Data
Mar. 23, 2018 (SG) 10201802424S

(51) Int. Cl. G06Q 30/02

(52) U.S. Cl. CPC G06Q 30/0215; G06Q 30/0222

(57) ABSTRACT

A voucher redemption method includes redeeming a voucher against a previous purchase based on a voucher-redemption request. The voucher-redemption request includes a voucher identifier of the voucher, an account identifier of an account, and a purchase order identifier associated with the previous purchase. The voucher is validated based on the voucher identifier and the purchase order identifier. When the voucher is valid, a voucher amount associated with the voucher is credited to the account specified in the voucher-redemption request. Hence, the voucher is redeemed.

### CROSS REFERENCE TO RELATED APPLICATIONS

This application claims priority to Singaporean Application Serial No. 10201802424S, filed Mar. 23, 2018, which is incorporated herein by reference in its entirety

### FIELD OF THE INVENTION

The present invention relates to a method and system for conducting electronic transactions, and more particularly to a method and system for voucher redemption against previous purchases.

### BACKGROUND

Market penetration always remains a key performance metric to measure business growth for any business. Hence, most business strategies of various business owners, including merchants, aim at increasing their market penetration. Examples of various business strategies adopted by the merchants include competitive pricing, enhanced marketing communications, or distribution of vouchers such as reward points, loyalty points, discount vouchers, and the like. From these business strategies, the distribution of vouchers is the most common approach adopted by the merchants to entice customers. For example, a customer, who has a discount voucher of a first apparel brand, will check the first apparel brand prior to checking other apparel brands when she wants to purchase clothes. In one scenario, a merchant may distribute a voucher to a customer as a reward for a prior engagement of the customer therewith or as a business promotion offer. In another scenario, the merchant may freely distribute or sell the voucher to potential customers.

Typically, such a voucher is required to be redeemed by the customer during a purchase. However, in a scenario, when the customer fails to redeem the voucher during the purchase, the voucher stands unused and the customer has to make another purchase for redeeming the voucher. In other words, a voucher cannot be retrospectively redeemed for a previous purchase. In addition, such vouchers have a fixed validity period. It may so happen that before the customer makes the next purchase, the validity period of the voucher expires. Hence, it is an inconvenience and a loss to the customer.

In light of the foregoing, there exists a need for a solution that enables customers to redeem vouchers against their previous purchases.

### SUMMARY

In an embodiment of the present invention, a voucher redemption method is provided. A voucher-redemption request is received by a first server (such as an aggregator server, a payment network server, or an issuer server) for redeeming a voucher against a previous purchase made by a user. The voucher-redemption request includes a voucher identifier of the voucher, an account identifier of an account, and a purchase order identifier associated with the previous purchase. A voucher-validation request is communicated to a second server (such as a merchant server) by the first server for validating the voucher. The voucher is validated based on the voucher identifier and the purchase order identifier. A validation response is received by the first server from the second server based on the voucher-validation request. The validation response includes a voucher amount associated with the voucher, when the voucher is valid. Redemption of the voucher is initiated by the first server when the voucher is valid. The account is credited with the voucher amount, when the voucher is redeemed.

In another embodiment of the present invention, a voucher redemption system is provided. The voucher redemption system includes a payment network server that includes a processor. The processor receives a voucher-redemption request for redeeming a voucher against a previous purchase made by a user. The voucher-redemption request includes a voucher identifier of the voucher, an account identifier of an account, and a purchase order identifier associated with the previous purchase. The processor communicates a voucher-validation request to a merchant server for validating the voucher. The voucher is validated based on the voucher identifier and the purchase order identifier. The processor receives a validation response from the merchant server based on the voucher-validation request. The validation response includes a voucher amount associated with the voucher, when the voucher is valid. The processor initiates a redemption of the voucher, when the voucher is valid. The account is credited with the voucher amount when the voucher is redeemed.

In yet another embodiment of the present invention, a voucher redemption method is provided. A voucher-redemption request for redeeming a voucher against a previous purchase made by a user is received by a merchant server. The voucher-redemption request includes a voucher identifier of the voucher, an account identifier of an account, and a purchase order identifier associated with the previous purchase. The voucher is validated by the merchant server based on the voucher identifier and the purchase order identifier. A validation response is generated by the merchant server. The validation response includes a voucher amount associated with the voucher when the voucher is valid. The voucher is redeemed based on the validation response. The account is credited with the voucher amount when the voucher is redeemed. Thus, the method and system of the present invention allow a user to retrospectively redeem vouchers against previous purchases, thereby eliminating the need to make another purchase for a voucher that was not redeemed in the previous purchase.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates a communication environment for redeeming vouchers, in accordance with an embodiment of the present invention;

FIG. 2 is a block diagram that illustrates a payment network server of the communication environment of FIG. 1, in accordance with an embodiment of the present invention;

FIG. 3 is a block diagram that illustrates an aggregator server of the communication environment of FIG. 1, in accordance with an embodiment of the present invention;

FIG. 4 is a block diagram that illustrates a merchant server of the communication environment of FIG. 1, in accordance with an embodiment of the present invention;

FIG. 5 is a block diagram that illustrates a graphical user interface (GUI) presented on a user-computing device for redeeming vouchers, in accordance with an embodiment of the present invention;

FIGS. 6A and 6B are process flow diagrams that illustrate exemplary scenarios for redeeming vouchers, in accordance with an embodiment of the present invention;

FIGS. 7A and 7B are process flow diagrams that illustrate exemplary scenarios for redeeming vouchers, in accordance with another embodiment of the present invention;

FIGS. 8A and 8B are process flow diagrams that illustrate exemplary scenarios for redeeming vouchers, in accordance with another embodiment of the present invention;

FIG. 9 represents a flow chart that illustrates a method for redeeming vouchers against previous purchases, in accordance with an embodiment of the present invention;

FIG. 10 represents a flow chart that illustrates a method for redeeming vouchers against previous purchases, in accordance with another embodiment of the present invention;

FIG. 11 represents a high-level flow chart that illustrates a method for redeeming vouchers against previous purchases, in accordance with an embodiment of the present invention;

FIG. 12 represents a high-level flow chart that illustrates a method for redeeming vouchers against previous purchases, in accordance with another embodiment of the present invention; and

FIG. 13 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

OVERVIEW

Various embodiments of the present invention provide a method and system for redeeming vouchers against previous purchases. A user may possess a voucher and may want to redeem the voucher against a purchase that is already completed. For redeeming the voucher, the user initiates a voucher-redemption request by accessing an application interface or a website that allows voucher redemption against previous purchases. The voucher-redemption request includes a voucher identifier (ID) of the voucher, an account ID of an account, and a purchase order ID of the previous purchase. A first server (such as a payment network server, an aggregator server, or a merchant server) receives the voucher-redemption request. The voucher is validated based on the voucher ID and the purchase order ID. When the voucher is invalid, redemption of the voucher is declined and the user is notified that the voucher is invalid for redemption against the previous purchase. Conversely, when the voucher is valid, the redemption of the voucher is initiated. When the voucher is redeemed, a voucher amount associated with the voucher is credited to the account corresponding to the account ID as specified in the voucher-redemption request. The method of redeeming the voucher against previous purchases may be implemented by the acquirer server, the payment network server, the aggregator server, the merchant server, the issuer server, or a combination thereof

Thus, the method and system of the present invention enable the user to redeem vouchers against previous purchases made by her without any inconvenience. Therefore, if the user fails to redeem a voucher at the time of purchase, the user no longer has to wait for a next purchase to redeem the voucher. By using the method and system of the present invention, the user may redeem the voucher at any time after the purchase and within the validity of the voucher.

TERMS DESCRIPTION (in addition to plain and dictionary meaning)

Voucher is a certificate that is provided to a user and has a certain monetary value. The user is entitled to a discount or a special offer worth the monetary value upon the use of the voucher. For example, a user gets a discount of USD 100 while purchasing a product worth USD 500, when she redeems a voucher that offers 20% discount upon a purchase of USD 400 or more. In one scenario, the voucher is provided by a merchant to the user as an engagement reward, a promotional reward, or the like. In another scenario, the user may purchase the voucher from the merchant at a nominal price. The user may redeem the voucher upon purchase or against a previous purchase that is already completed. Examples of the voucher include, but are not limited to, gift cards, discount coupons, promotional offers, scratch card coupons, tokens, reward points, or offer codes. In one embodiment, the voucher is a physical entity, such as a printed paper. In another embodiment, the voucher is a virtual entity that is electronically stored in a memory of a computing device of the user.

Previous purchase is a purchase transaction performed by a user in the past. The previous purchase is associated with details such as a purchase order identifier (ID), a purchase amount, a purchase date, and a voucher ID of a voucher that is provided by a merchant to the user corresponding to the previous purchase. In one scenario, when the user has failed to redeem a voucher while performing a purchase, the user may redeem the voucher at a time instance that is after the completion of the purchase. An amount of the voucher is then credited to an account of the user. In such a scenario, the purchase is referred to as the previous purchase.

Validation is a process to verify whether a voucher is valid or invalid. The voucher is validated before redemption to ensure that the voucher is valid for a corresponding purchase. In one example, if a user tries to redeem a one-time usable voucher for a second time, the voucher stands invalid for the second time. In another example, a voucher that is specific to the purchase of a first product category stands invalid for redemption for the purchase of a second product category. In yet another example, a voucher may stand invalid for redemption beyond the validity period of the voucher.

Transaction cards are payment devices, such as debit cards, credit cards, prepaid cards, promotional cards, contactless cards, and/or other devices that may hold identification information of an account. The transaction cards can be used to perform transactions, such as deposits and withdrawals, credit transfers, purchase payments, and the like. In an embodiment, the transaction cards may be radio frequency identification (RFID) or NFC enabled for performing contactless payments.

Merchant is an entity that offers various products and/or services in exchange of payments. The merchant may establish a merchant account with a financial institution, such as a bank (hereinafter “acquirer bank”) to accept the payments from several users by use of one or more payment methods. The merchant further provides one or more vouchers to users as engagement rewards or promotion rewards. For example, the merchant may provide a voucher that offers 50% discount to its customers, on the 20^{th} purchase made by each customer.

Issuer or issuer bank is a financial institution, such as a bank, where accounts of several users are established and maintained. The issuer bank ensures payment for authorized transactions in accordance with various payment network regulations and local legislation.

Payment network is a transaction card association that acts as an intermediate entity between acquirer banks and issuer banks to authorize and fund transactions. Examples of payment networks include MasterCard®, American Express®, VISA®, Discover®, Diners Club®, and the like. The payment network settles the transactions between various acquirer banks and issuer banks, when transaction cards are used for initiating transactions. For example, if a user uses a stolen debit card for performing a transaction, the payment network does not authorize the transaction. In one embodiment, the payment network facilitates voucher redemption against previous purchases performed by users.

Aggregator is a payment aggregator that aggregates various merchants on a single platform. The aggregator serves as an intermediate entity between the merchants and at least one of payment networks and banks. Examples of aggregators include, but are not limited to, Atos® and CyberPlat®.

A server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of a payment network server, an issuer server, an aggregator server, an acquirer server, or a merchant server.

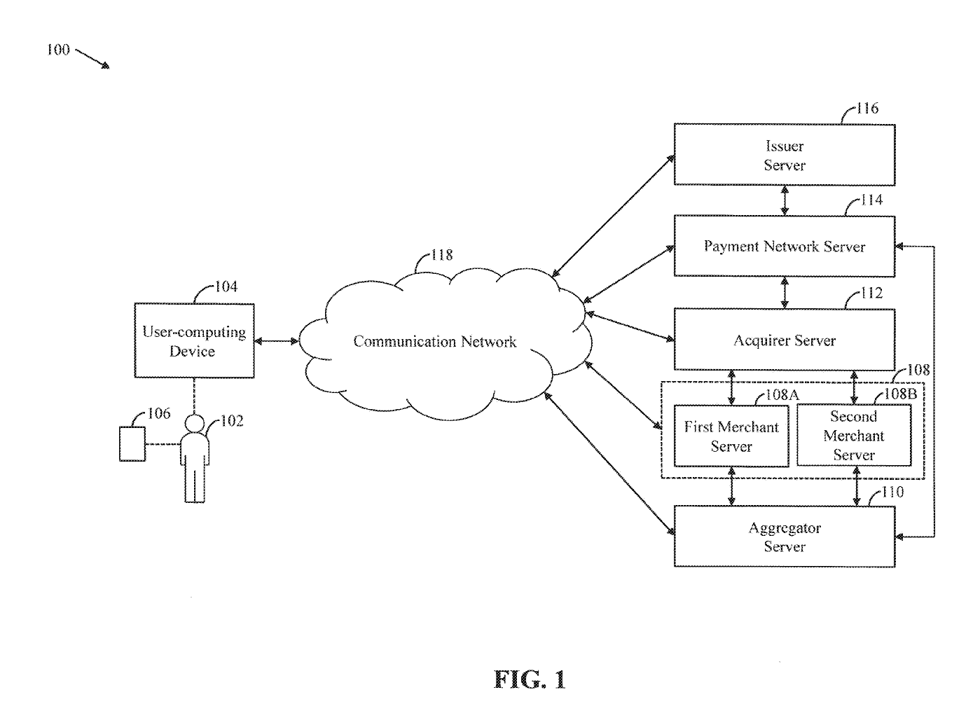

Referring now to FIG. 1, a block diagram that illustrates a communication environment 100 for redeeming vouchers, in accordance with an embodiment of the present invention, is shown. The communication environment 100 includes a user 102 in possession of a user-computing device 104 and a transaction card 106. The communication environment 100 further includes first and second merchant servers 108A and 108B (hereinafter collectively referred to as “merchant servers 108”), an aggregator server 110, an acquirer server 112, a payment network server 114, and an issuer server 116. The user-computing device 104 communicates with the merchant servers 108, the aggregator server 110, the acquirer server 112, the payment network server 114, and the issuer server 116 by way of a communication network 118.

The user 102 is an individual, who is an account holder of an account. In one embodiment, the account is a digital wallet maintained by a third-party service provider or a merchant. In another embodiment, the account is a bank account maintained by a financial institution, such as an issuer bank. The account is linked to the transaction card 106 and thus the transaction card 106 stores identification information of the account (hereinafter referred to as “account identification information of the account”). The account identification information may be stored in the form of an electronic chip or a machine readable magnetic strip embedded in the transaction card 106. The account identification information may include an account number, a name of an account holder (i.e., the user 102), or the like. The transaction card 106 has a unique card number, an expiry date, a card security code, and a card type associated to it. The card number, the expiry date, the card security code, and the card type constitute transaction card details of the transaction card 106. In one embodiment, the transaction card 106 is a physical card. In another embodiment, the transaction card 106 is a virtual card that is stored electronically in memory (not shown) of the user-computing device 104. Examples of the transaction card 106 include a credit card, a debit card, a membership card, a promotional card, a charge card, a prepaid card, or the like.

The user 102 may possess one or more vouchers that entitle the user 102 to discounts or specific offers upon use. Examples of the vouchers include, but are not limited to, gift cards, discount coupons, promotional offers, scratch card coupons, tokens, reward points, or offer codes. In one embodiment, the vouchers are physical vouchers, such as printed vouchers. In another embodiment, the vouchers are virtual vouchers that are stored electronically in the memory of the user-computing device 104. In one scenario, the user 102 redeems a voucher upon a purchase and gets the discount or the specific offer at the time of purchase. In another scenario, the user 102 redeems the voucher against a previous purchase made by her. In this scenario, the discount is credited to the account of the user 102 when the voucher is redeemed. In other words, the user 102 has an option to redeem the voucher against the previous purchase without making a new purchase. For redeeming the voucher against the previous purchase, the user 102 initiates a voucher-redemption request by accessing one of an application interface or a website that enables voucher redemption against previous purchases.

The user-computing device 104 is a communication device of the user 102. The user 102 uses the user-computing device 104 for accessing the application interface or the website to initiate voucher-redemption requests for redeeming the vouchers against previous purchases. The application interface may be installed on the memory of the user-computing device 104. Examples of the user-computing device 104 include, but are not limited to, a mobile phone, a smartphone, a laptop, a tablet, a phablet, or any other communication device.

The merchant servers 108 are computing servers that are associated with merchants. For example, the first merchant server 108A is associated with a first merchant and the second merchant server 108B is associated with a second merchant. The merchants may establish merchant accounts with financial institutions, such as acquirer banks, to accept payments for products and/or services purchased and/or availed by various users. For example, the first and second merchants have first and second merchant accounts, respectively, that are established at an acquirer bank. In one scenario, the first and second merchants may distribute vouchers to users, when the users purchase or avail products and/or services from them. In another scenario, the first and second merchants may sell the vouchers to the users at nominal price. The merchant servers 108 store voucher information of the vouchers distributed to the users by the corresponding merchant. The voucher information of a voucher includes a voucher identifier (ID), a status of the voucher, a discount or special offer details associated with the voucher, a validity period of the voucher, or the like. The merchant servers 108 further maintain purchase history of each user. The purchase history of each user represents details of all previous purchases made by the corresponding user. For example, the purchase history of the user 102 maintained by the first merchant server 108A represents details of all previous purchases made by the user 102 from the first merchant. The details of a purchase may include a purchase order ID, a purchase amount, a purchase date, and a voucher ID of a voucher that is provided by the first merchant to the user 102 corresponding to the purchase. The purchase order ID is unique identifier assigned to each purchase. The purchase amount represents the amount the user 102 had paid during the purchase. The purchase date represents the date on which the user 102 made the purchase. The details of the purchase may further include an indicator whether the user 102 had used a voucher while purchasing, and if yes, the details of the voucher used.

The aggregator server 110 is a computing server that is used by a payment aggregator for aggregating various merchants (such as the first and second merchants) on a single platform. The aggregator server 110 serves as an intermediate entity between the payment network server 114 and the merchant servers 108. The aggregator server 110 receives various voucher-redemption requests and routes each voucher-redemption request to the corresponding merchant server for processing. Examples of various payment aggregators include Atos, CyberPlat, or the like.

The acquirer server 112 is a computing server that is associated with the acquirer bank. The acquirer bank processes transaction and voucher-redemption requests received from the merchant servers 108 by using the acquirer server 112. The acquirer server 112 transmits the transaction and voucher-redemption requests to payment networks or issuer banks, via the communication network 118. The acquirer server 112 credits or debits the first and second merchant accounts in the acquirer bank based on the transaction and voucher-redemption requests.

The payment network server 114 is a computing server that is associated with a payment network of various transaction cards, such as the transaction card 106. The payment network server 114 represents an intermediate entity between the acquirer server 112 and the issuer server 116 for authorizing and funding the transactions performed by using the transaction cards, such as the transaction card 106. The payment network server 114 further provides a platform to redeem vouchers against previous purchases made by the users, such as the user 102. The payment network server 114 generates credit and/or debit notifications based on the transaction and voucher-redemption requests. The credit and/or debit notifications are communicated to the acquirer and issuer servers 112 and 116 for crediting and/or debiting the accounts corresponding to the transaction and voucher-redemption requests. Examples of various payment networks include MasterCard, American Express, VISA, Discover, Diners Club, or the like.

It will be apparent to a person skilled in the art that the scope of the invention is not limited to realizing the payment network server 114 and the aggregator server 110 as separate entities. In various other embodiments, the functionalities of the aggregator server 110 can be integrated into the payment network server 114, without departing from the scope of the invention.

The issuer server 116 is a computing server that is associated with the issuer bank. The issuer bank is a financial institution that manages accounts of multiple users. Account details of the accounts established with the issuer bank are stored as account profiles in a memory of the issuer server 116 or on a cloud server associated with the issuer server 116. The account details may include an account balance, a credit line, details of an account holder, transaction history of the account holder, account identification information, or the like. The details of the account holder may include name, age, gender, physical attributes, registered contact number, alternate contact number, registered e-mail ID, or the like of the account holder. The issuer server 116 receives various credit and debit notifications from the payment network server 114. Based on the credit and debit notifications, the issuer server 116 credits and debits the corresponding accounts, respectively. Methods for crediting and debiting accounts via the issuer server 116 will be apparent to persons having skill in the art and may include processing via the traditional four-party system or the traditional three-party system.

Examples of the merchant servers 108, the aggregator server 110, the acquirer server 112, the payment network server 114, and the issuer server 116 include, but are not limited to, computers, laptops, mini-computers, mainframe computers, any non-transient and tangible machines that can execute a machine-readable code, cloud-based servers, distributed server networks, or a network of computer systems.

The communication network 118 is a medium through which content and messages are transmitted between various entities, such as the user-computing device 104, the merchant servers 108, the aggregator server 110, the acquirer server 112, the payment network server 114, and the issuer server 116. Examples of the communication network 118 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the communication environment 100 may connect to the communication network 118 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G) communication protocols, Long Term Evolution (LTE) communication protocols, or any combination thereof.

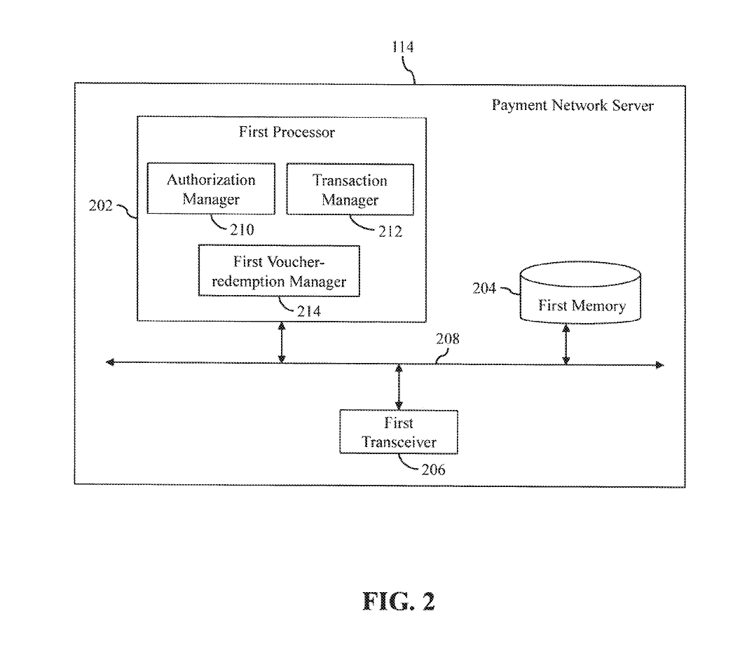

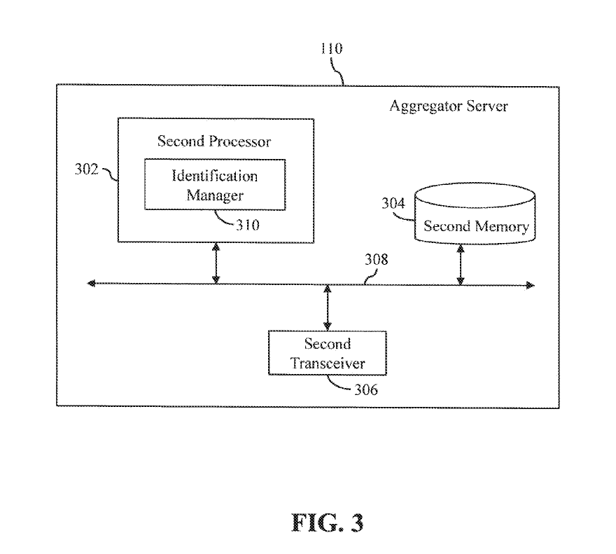

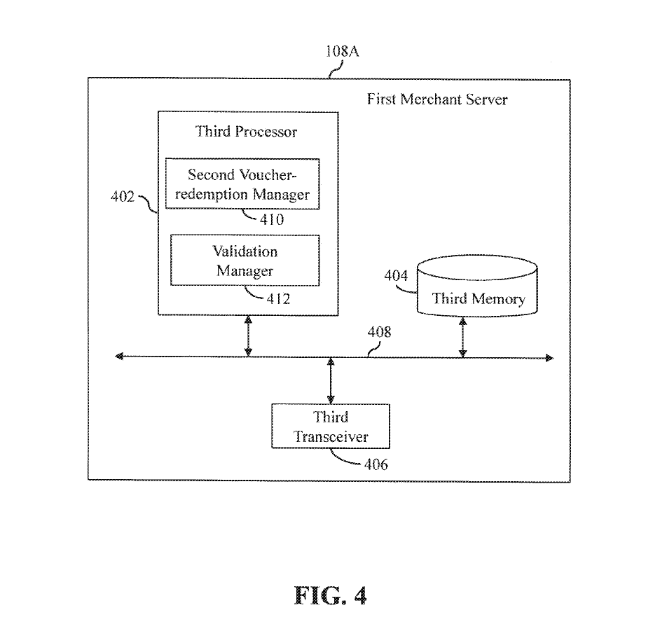

Various components of the payment network server 114, the aggregator server 110, and the first merchant server 108A are explained in detail in conjunction with FIG. 2, FIG. 3, and FIG. 4, respectively.

Referring now to FIG. 2, a block diagram that illustrates the payment network server 114 of the communication environment 100 of FIG. 1, in accordance with an embodiment of the present invention, is shown. The payment network server 114 includes a first processor 202, a first memory 204, and a first transceiver 206 that communicate with each other via a first bus 208. The first processor 202 includes an authorization manager 210, a transaction manager 212, and a first voucher-redemption manager 214. It will be apparent to a person skilled in the art that the acquirer server 112 and the issuer server 116 may also be implemented by the block diagram of FIG. 2, without deviating from the scope of the invention.

The first processor 202 includes suitable logic, circuitry, and/or interfaces to execute operations for redeeming vouchers against previous purchases of the users. The first processor 202 executes authorization of various transactions performed by the users (such as the user 102) for purchasing and/or availing products and/or services from various merchants. Examples of the first processor 202 include, but are not limited to, an application-specific integrated circuit (ASIC) processor, a reduced instruction set computing (RISC) processor, a complex instruction set computing (CISC) processor, a field-programmable gate array (FPGA), and the like. The first processor 202 executes the operations for redeeming vouchers and authorizing transactions by way of the authorization manager 210, the transaction manager 212, and the first voucher-redemption manager 214.

The first memory 204 includes suitable logic, circuitry, and/or interfaces to store account profiles for the accounts that are maintained at partner issuer and acquirer banks. Examples of the first memory 204 include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the first memory 204 in the payment network server 114, as described herein. In another embodiment, the first memory 204 may be realized in form of a database server or a cloud storage working in conjunction with the payment network server 114, without departing from the scope of the invention.

The first transceiver 206 transmits and receives data over the communication network 118 using one or more communication network protocols. The first transceiver 206 transmits/receives various requests and messages to/from at least one of the user-computing device 104, the merchant servers 108, the aggregator server 110, the acquirer server 112, the issuer server 116, or other entities that are pursuant to one or more standards for the interchange of transaction messages, such as the ISO8583 standard. Examples of the first transceiver 206 include, but are not limited to, an antenna, a radio frequency transceiver, a wireless transceiver, a Bluetooth transceiver, an ethernet port, a universal serial bus (USB) port, or any other device configured to transmit and receive data.

The authorization manager 210 includes suitable logic, circuitry, and/or interfaces for authorizing transactions that are performed by the user 102 for purchasing and/or availing products and/or services from the first and second merchants. The authorization manager 210 authorizes a transaction, when verification of account identification information or transaction card details corresponding to the transaction is successful. The authorization manager 210 does not authorize the transaction, when the verification of the account identification information or the transaction card details corresponding to the transaction is unsuccessful. The authorization manager 210 authorizes the transactions by implementing various authorization techniques known in the art.

The transaction manager 212 includes suitable logic, circuitry, and/or interfaces for generating the credit or debit notifications based on the corresponding transaction and voucher-redemption requests that are authorized. The transaction manager 212 communicates the credit or debit notifications to the issuer and acquirer servers 116 and 112 by way of the first transceiver 206.

The first voucher-redemption manager 214 includes suitable logic, circuitry, and/or interfaces for managing the voucher redemption against previous purchases made by the users from the first and second merchants. The first voucher-redemption manager 214 declines voucher redemption, when a voucher used is invalid and initiates the voucher redemption, when the voucher used is valid.

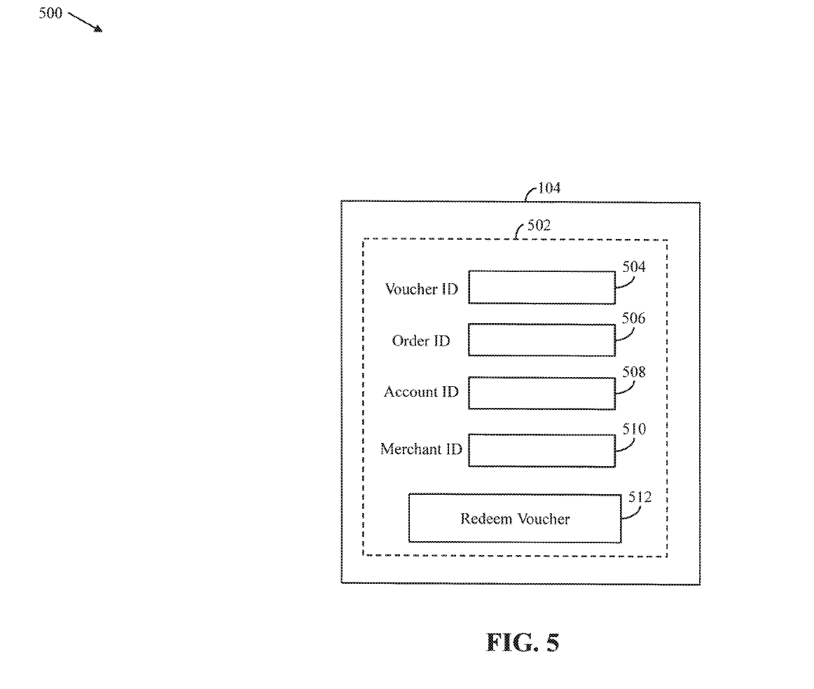

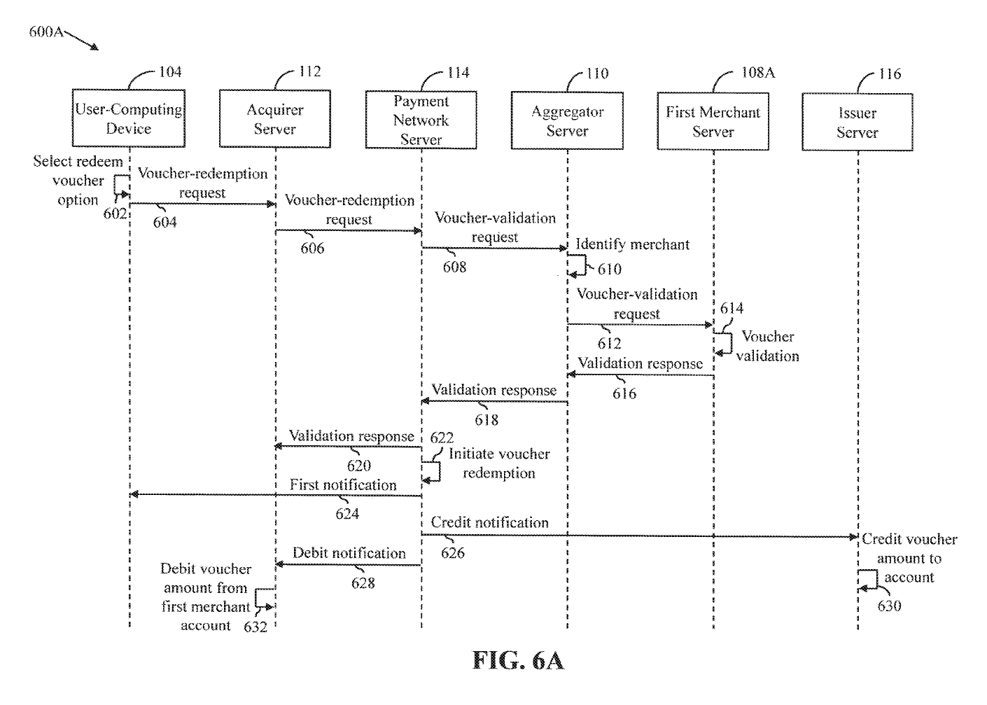

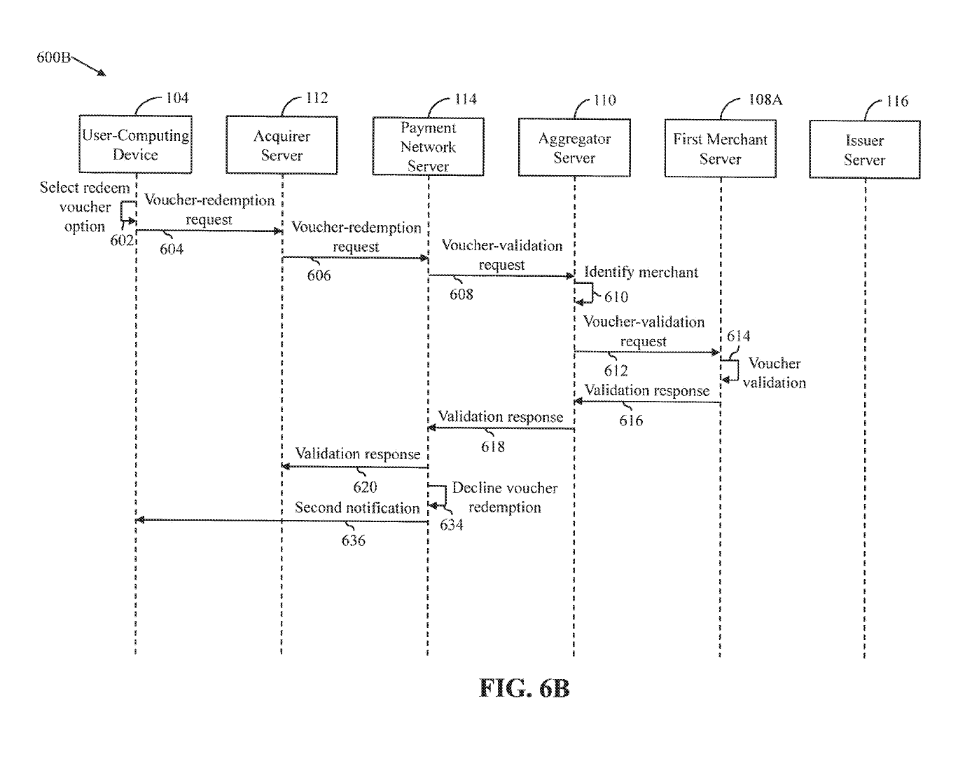

The functions performed by the payment network server 114 are explained later in detail in conjunction with FIG. 5 and FIGS. 6A and 6B.

Referring now to FIG. 3, a block diagram that illustrates the aggregator server 110 of the communication environment 100 of FIG. 1, in accordance with an embodiment of the present invention, is shown. The aggregator server 110 includes a second processor 302, a second memory 304, and a second transceiver 306 that communicate with each other via a second bus 308. The second processor 302 includes an identification manager 310.

The second processor 302 includes suitable logic, circuitry, and/or interfaces to execute operations for aggregating various merchants on a single platform. The second processor 302 further routes each voucher-redemption request to a corresponding merchant server. Examples of the second processor 302 include, but are not limited to, an ASIC processor, a RISC processor, a CISC processor, an FPGA, and the like. The second processor 302 routes the voucher-redemption requests by way of the identification manager 310.

The second memory 304 includes suitable logic, circuitry, and/or interfaces to store details of various merchants, which have partnered with the payment aggregator. Examples of the second memory 304 include a RAM, a ROM, a removable storage drive, a HDD, a flash memory, a solid-state memory, and the like. It will be apparent to a person skilled in the art that the scope of the invention is not limited to realizing the second memory 304 in the aggregator server 110, as described herein. In other embodiments, the second memory 304 may be realized in form of a database server or a cloud storage working in conjunction with the aggregator server 110, without departing from the scope of the invention.

The second transceiver 306 transmits and receives data over the communication network 118 using one or more communication network protocols. The second transceiver 306 transmits/receives various requests and messages to/from at least one of the user-computing device 104, the merchant servers 108, the acquirer server 112, the payment network server 114, the issuer server 116, or other entities that are pursuant to one or more standards for the interchange of transaction messages, such as the ISO8583 standard. Examples of the second transceiver 306 include, but are not limited to, an antenna, a radio frequency transceiver, a wireless transceiver, a Bluetooth transceiver, an ethernet port, a USB port, or any other device configured to transmit and receive data.

The identification manager 310 includes suitable logic, circuitry, and/or interfaces for identifying a merchant corresponding to a voucher-redemption request. For example, the identification manager 310 receives a voucher-redemption request initiated by the user 102 for redeeming a voucher. Based on the voucher-redemption request, the identification manager 310 identifies that the first merchant had provided the voucher to the user 102. Thus, the identification manager 310 routes the voucher-redemption request to a merchant server (the first merchant server 108A in this scenario) associated with the identified merchant. The functions performed by the aggregator server 110 are explained later in conjunction with FIGS. 6A and 6B.

Referring now to FIG. 4, a block diagram that illustrates the first merchant server 108A of the communication environment 100 of FIG. 1, in accordance with an embodiment of the present invention, is shown. The first merchant server 108A includes a third processor 402, a third memory 404, and a third transceiver 406 that communicate with each other via a third bus 408. The third processor 402 includes a second voucher-redemption manager 410 and a validation manager 412. It will be apparent to a person skilled in the art that the second merchant server 108B may also be implemented by the block diagram of FIG. 4, without deviating from the scope of the invention.

The third processor 402 includes suitable logic, circuitry, and/or interfaces to execute operations for handling the voucher-redemption requests and validating vouchers based on the corresponding voucher-redemption requests. Examples of the third processor 402 include, but are not limited to, an ASIC processor, a RISC processor, a CISC processor, an FPGA, and the like. The third processor 402 executes the operations by way of the second voucher-redemption manager 410 and the validation manager 412.

The third memory 404 includes suitable logic, circuitry, and/or interfaces to store the voucher information of the vouchers provided to the users by the first merchant. The third memory 404 further stores the purchase history of each user, who has made purchases at the first merchant. Examples of the third memory 404 include a RAM, a ROM, a removable storage drive, a HDD, a flash memory, a solid-state memory, and the like. It will be apparent to a person skilled in the art that the scope of the invention is not limited to realizing the third memory 404 in the first merchant server 108A, as described herein. In other embodiments, the third memory 404 may be realized in form of a database server or a cloud storage working in conjunction with the first merchant server 108A, without departing from the scope of the invention.

The third transceiver 406 transmits and receives data over the communication network 118 using one or more communication network protocols. The third transceiver 406 transmits/receives various requests and messages to/from at least one of the user-computing device 104, the aggregator server 110, the acquirer server 112, the payment network server 114, and the issuer server 116, or other entities that are pursuant to one or more standards for the interchange of transaction messages, such as the ISO8583 standard. Examples of the third transceiver 406 include, but are not limited to, an antenna, a radio frequency transceiver, a wireless transceiver, a Bluetooth transceiver, an ethernet port, a USB port, or any other device configured to transmit and receive data.

The second voucher-redemption manager 410 includes suitable logic, circuitry, and/or interfaces for updating the voucher information stored in the third memory 404, based on the voucher-redemption requests. For example, if the user 102 redeems her one-time usable voucher, the second voucher-redemption manager 410 updates the voucher information by changing the status of the one-time usable voucher from “active” to “inactive” or from “redeemable” to “redeemed”.

The validation manager 412 includes suitable logic, circuitry, and/or interfaces for validating vouchers based on the corresponding voucher-redemption requests. The validation manager 412 validates a voucher by referring to the purchase history of the user 102 (who had initiated the voucher-redemption request) and the voucher information of the corresponding voucher. The functions performed by the first merchant server 108A are explained later in detail in conjunction with FIGS. 6A and 6B.

Referring now to FIG. 5, an exemplary scenario 500 for presenting a graphical user interface (GUI) 502 on the user-computing device 104 for redeeming vouchers, in accordance with an embodiment of the present invention, is shown. In various embodiments, the GUI 502 is presented on a display (not shown) of the user-computing device 104 by one of the application interface or the website hosted by one of the payment network server 114, the merchant servers 108, the issuer server 116 for redeeming the vouchers against previous purchases. Examples of the display include, but are not limited to, Thin-Film-Transistor (TFT) Liquid-Crystal Display (LCD), an In-Plane Switching (IPS) LCD, a Resistive Touchscreen LCD, a Capacitive Touchscreen LCD, an Organic Light Emitting Diode (OLED) display, an Active-Matrix Organic Light-Emitting Diode (AMOLED) display, a Super AMOLED display, a Retina Display, or a Haptic/Tactile touchscreen-based display.

The GUI 502 allows the user 102 to initiate voucher-redemption requests for redeeming vouchers against previous purchases. The GUI 502 may be designed using a GUI builder software such as Atmel Qtouch®, Altia Design®, GrabCAD®, and the like. The GUI 502 includes first through fourth input sections 504-510. In one embodiment, when the GUI 502 is presented by the merchant servers 108, the fourth input section 510 is absent in the GUI 502. In another embodiment, when the GUI 502 is presented by the merchant servers 108, the fourth input section 510 is automatically populated with a merchant ID of the corresponding merchant.

The first input section 504 allows the user 102 to input a voucher ID of a voucher that she wishes to redeem. The second input section 506 allows the user 102 to input a purchase order ID of a previous purchase against which the user 102 wishes to redeem the voucher. The third input section 508 allows the user 102 to input an account ID (such as the account number of the account or the card number of the transaction card 106) of an account, which the user 102 wishes to be credited with a voucher amount of the voucher when the voucher is redeemed. The fourth input section 510 allows the user 102 to input the merchant ID of the merchant corresponding to the voucher. The GUI 502 further includes a redeem voucher tab 512 for initiating a voucher-redemption request. In one embodiment, the redeem voucher tab 512 remains inactive when at least one of the first through fourth input sections 504-510 is not inputted with required details. The redeem voucher tab 512 becomes active when each of the first through fourth input sections 504-510 is inputted with required details. In another scenario, when vouchers are unique, the purchase order ID is optional. Thus, the redeem voucher tab 512 becomes active when the first, third, and fourth input sections 504, 508, and 510 are inputted with required details. The operation of the GUI 502 is explained later in conjunction with FIGS. 6A and 6B.

It will be apparent to persons having ordinary skill in the art that the above-mentioned GUI 502 is for illustrative purpose and should not be construed to limit the scope of the invention in any way.

Referring now to FIGS. 6A and 6B, process flow diagrams 600A and 600B that illustrate exemplary scenarios for redeeming vouchers, in accordance with an embodiment of the present invention, are shown. The process flow diagrams 600A and 600B illustrate scenarios when the GUI 502 is presented on the user-computing device 104 by one of the application interface or the website hosted by the first merchant server 108A.

With reference to FIG. 6A, the process flow diagram 600A illustrates the user-computing device 104, the first merchant server 108A, the aggregator server 110, the acquirer server 112, the payment network server 114, and the issuer server 116. The user 102 purchases a first product from the first merchant by initiating a first transaction from the account. When the first transaction is successful, a purchase amount of the first product is debited from the account and credited to the first merchant account. While purchasing the first product, the user 102 may not have redeemed a voucher available with her and hence wishes to redeem the voucher at a later point of time, against the previous purchase of the first product.

For redeeming the voucher against the previous purchase, the user 102 accesses the application interface or the website hosted by the first merchant server 108A through the user-computing device 104. The application interface or the website presents the GUI 502 on the display of the user-computing device 104. The user 102 inputs the voucher ID of the voucher, the purchase order ID associated with the purchase of the first product, and the account ID (i.e., the card number of the transaction card 106) in the first through third input sections 504-508, respectively. When the first through third input sections 504-508 are inputted with the required details, the redeem voucher tab 512 becomes active. The user 102 clicks on the redeem voucher tab 512 to select the redeem voucher option (depicted by arrow 602).

When the user 102 clicks on the redeem voucher tab 512, a voucher-redemption request (depicted by arrow 604) is initiated through the application interface or the website and is communicated to the acquirer server 112 over the communication network 118. The voucher-redemption request includes one or more data fields that are pursuant to one or more standards for the interchange of transaction messages, such as the ISO8583 standard. The data fields include the voucher ID, the purchase order ID, the account ID, and the merchant ID. For example, the voucher ID, the purchase order ID, the account ID, and the merchant ID are included as four sub-elements of data element (DE) 48 of the voucher-redemption request. DE 48 represents a private data field that is pursuant to the ISO8583 standard for the interchange of transaction messages.

The acquirer server 112 receives the voucher-redemption request and categorizes it under a voucher-redemption transaction category. In one scenario, when the acquirer server 112 receives a request for which DE 48 is null, the request is categorized under a regular transaction category. The acquirer server 112 transmits the voucher-redemption request (depicted by arrow 606) to the payment network server 114.

The first transceiver 206 receives the voucher-redemption request. Based on the voucher-redemption request, the first voucher-redemption manager 214 generates a voucher-validation request for validating the voucher. The voucher-validation request includes the voucher ID, the purchase order ID, the account ID, and the merchant ID as the data fields that are pursuant to the ISO8583 standard for the interchange of transaction messages. The first transceiver 206 communicates the voucher-validation request (depicted by arrow 608) to the aggregator server 110. In another embodiment, the first transceiver 206 communicates the voucher-redemption request to the aggregator server 110, which in turn generates the voucher-validation request.

The second transceiver 306 receives the voucher-validation request. Based on the merchant ID of the first merchant included in the voucher-validation request, the identification manager 310 identifies a merchant (such as the first merchant) that corresponds to the voucher (depicted by arrow 610). The second transceiver 306 thus routes the voucher-validation request (depicted by arrow 612) to the first merchant server 108A. In another embodiment, when various merchants partner with the payment network, the functionality of the aggregator server 110 is performed by the payment network server 114. In such a scenario, the first transceiver 206 communicates the voucher-validation request directly to the first merchant server 108A.

The third transceiver 406 receives the voucher-validation request. The validation manager 412 performs a validation (depicted by arrow 614) of the voucher, based on the voucher-validation request. The validation manager 412 retrieves the voucher information of the voucher from the third memory 404 using the voucher ID and the purchase details of the first product from the purchase history of the user 102 using the purchase order ID. The validation manager 412 uses the voucher information of the voucher, the purchase details of the first product, and one or more validation rules to determine whether the voucher is valid or invalid. The one or more validation rules are stored in the third memory 404. In other words, the validation manager 412 validates the voucher based on the voucher ID, the purchase order ID, and the one or more validation rules. The one or more validation rules include a validation period rule, a minimum purchase amount rule, a voucher status rule, and/or the like.

In one example, the validation manager 412 determines that the voucher has a validation period from Dec. 12, 2017 to Jan. 15, 2018 and the purchase date of the first product is Dec. 10, 2017. In such a scenario, based on the validation period rule, the validation manager 412 determines that the voucher is invalid against the purchase of the first product. However, the voucher stands valid, if the date of the purchase of the first product is between Dec. 12, 2017 and Jan. 15, 2018. In another example, the validation manager 412 determines that the voucher is valid for a purchase amount greater than USD 3,000 and the purchase amount of the first product is USD 3,500. In such a scenario, based on the minimum purchase amount rule, the validation manager 412 determines that the voucher is valid against the purchase of the first product. However, the voucher stands invalid, if the purchase amount of the first product is below USD 3,000. In yet another example, based on the voucher status rule, the validation manager 412 determines that the voucher is invalid, when the status of the voucher is “inactive”. In yet another example, the validation manager 412 determines that the voucher is invalid, when at least one of the purchase details of the first product and the voucher information of the voucher is unavailable. In yet another example, the validation manager 412 determines that the voucher submitted by the user 102 is a real-time purchase voucher. The validation manager 412 determines that the voucher cannot be redeemed retrospectively and hence invalidates the voucher. It will be apparent to one skilled in the art that the validation manager 412 may use one or more other validation techniques known in the art for validating the voucher without departing from the scope of the invention. The process flow diagram 600A illustrates the scenario, when the voucher is valid.

When the voucher is valid, the second voucher-redemption manager 410 identifies a voucher amount of the voucher. The voucher amount indicates a monetary value of the voucher. The second voucher-redemption manager 410 determines the voucher amount based on at least one of the voucher information of the voucher and the purchase details of the first product. In one example, the voucher offers a flat discount of USD 50, thus the voucher amount is USD 50. In another example, the voucher offers 20% discount on the purchase of the first product. Thus, when the purchase amount of the first product is USD 3,000, the voucher amount becomes USD 600. In yet another example, the voucher is associated with a decay factor of 0.5 per unit time (for example, per day, per week, per month, and/or the like). The user 102 is informed regarding the decay factor at the time she receives the voucher. In such a scenario, when the user 102 applies a voucher (which offers a discount of USD 100 and has a decay factor of 0.5 per week) within a first week after the purchase of the first product, the second voucher-redemption manager 410 determines the voucher amount to be USD 100. However, when the user 102 applies the voucher within a second week after the purchase of the first product, the second voucher-redemption manager 410 determines the voucher amount to be 50% of USD 100 (i.e., USD 50). Thus, the voucher amount decreases based on the decay factor and a time instance at which the user 102 redeems the voucher.

The second voucher-redemption manager 410 generates a validation response to indicate a result of the validation performed by the validation manager 412. The validation response is pursuant to the ISO8583 standard for the interchange of transaction messages and includes the voucher amount. For example, the result of the validation and the voucher amount are included as DE 39 and DE 4, respectively, in the validation response. In one scenario, value of the DE 39 is “00” when the voucher is valid and “11” when the voucher is invalid. In one embodiment, the validation response may further include account identification information of the first merchant account of the first merchant. The third transceiver 406 communicates the validation response (depicted by arrow 616) to the aggregator server 110. The second transceiver 306 receives the validation response and transmits it (depicted by arrow 618) to the payment network server 114. In another embodiment, the third transceiver 406 directly communicates the validation response to the payment network server 114. The first transceiver 206 communicates the validation response (depicted by arrow 620) to the acquirer server 112 for notifying that the voucher is valid for redemption. The first voucher-redemption manager 214 initiates the redemption (depicted by arrow 622) of the voucher and notifies the user 102 by way of a first notification (depicted by arrow 624) that the voucher is redeemed. The user 102 may receive the first notification at the user-computing device 104.

For redeeming the voucher, the transaction manager 212 generates a credit notification. The credit notification includes the account ID, a bank identification number of the issuer bank, a bank identification number of the acquirer bank, the voucher amount, a currency ID corresponding to the account ID, and a first timestamp. The bank identification number represents a unique identification code allotted to every bank. The currency ID represents the currency associated with the account or the transaction card 106 as mentioned in the account ID. The first timestamp indicates a time instance at which the credit notification is generated. The first transceiver 206 transmits the credit notification (depicted by arrow 626) to the issuer server 116.

In one embodiment, the transaction manager 212 further generates a debit notification. The debit notification includes the account identification information of the first merchant account, the bank identification numbers of the issuer and acquire banks, the voucher amount, a currency ID corresponding to the first merchant account, and a second timestamp. The second timestamp indicates a time instance at which the debit notification is generated. The first transceiver 206 transmits the debit notification (depicted by arrow 628) to the acquirer server 112.

The issuer server 116 receives the credit notification and credits (depicted by arrow 630) the account of the user 102 with the voucher amount. The acquirer server 112 receives the debit notification and deducts (depicted by arrow 632) the voucher amount from the first merchant account. In one embodiment, the issuer server 116 does not levy an interchange fee or commission while crediting the account of the user 102 with the voucher amount. Thus, the account of the user 102 is credited with the voucher amount and the voucher is redeemed. When the voucher is redeemed, the second voucher-redemption manager 410 changes the status of the voucher stored in the third memory 404 from “active” to “inactive”. The credit of the voucher amount is reflected in an account statement of the account. The account statement thus includes details of the transaction of the previous purchase against which the voucher is redeemed. Hence, the account statement enables the user 102 to keep a track on the voucher redemption. For example, the user 102 initiates a redemption of two vouchers against two previous purchases, and only one is actually redeemed. In such a scenario, the account statement enables the user 102 to identify the previous purchase against which the voucher is redeemed.

With reference to FIG. 6B, the process flow diagram 600B illustrates the scenario, when the voucher is invalid. The first transceiver 206 receives the validation response (depicted by arrow 618) indicating that the voucher is invalid. Thus, the first voucher-redemption manager 214 communicates the validation response (depicted by arrow 620) to the acquirer server 112 to notify that the voucher is invalid for redemption. The first voucher-redemption manager 214 declines (depicted by arrow 634) the voucher redemption of the voucher based on the validation response and notifies the user 102 by way of a second notification (depicted by arrow 636) that the voucher is invalid for redemption.

The payment network server 114 enables the user 102 to redeem the voucher against the previous purchase without any inconvenience. Thus, the user 102 no longer requires waiting for a next purchase to redeem the voucher, if she did not redeem the voucher during the previous purchase. In addition, the payment network server 114 allows redemption of only the vouchers that are valid, thereby preventing any monetary loss to the merchants.

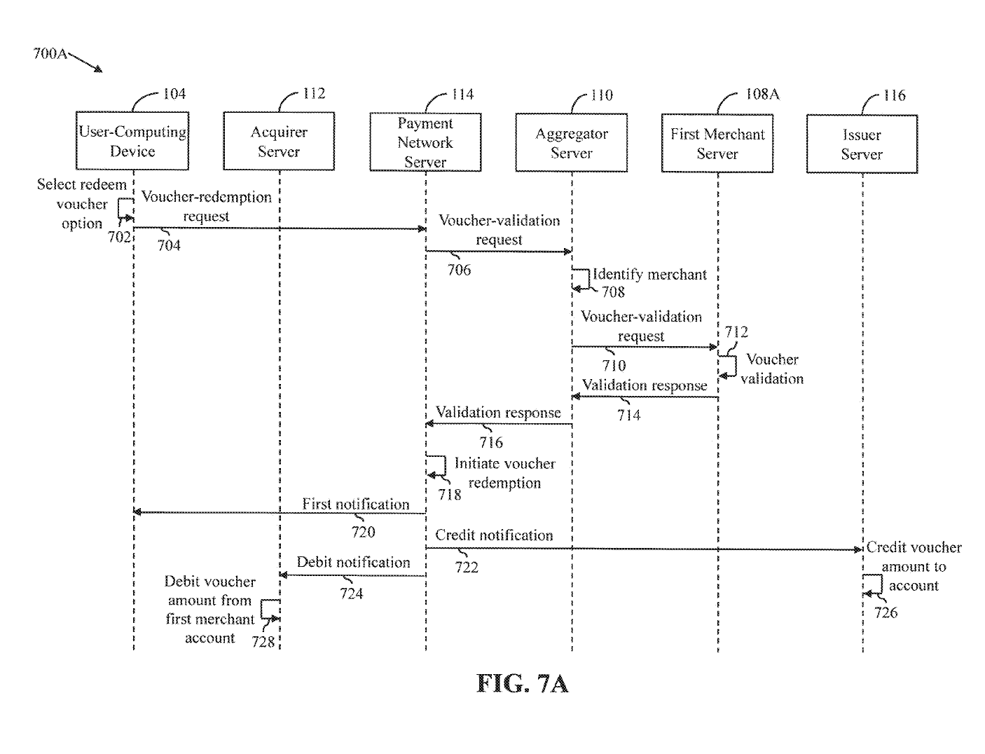

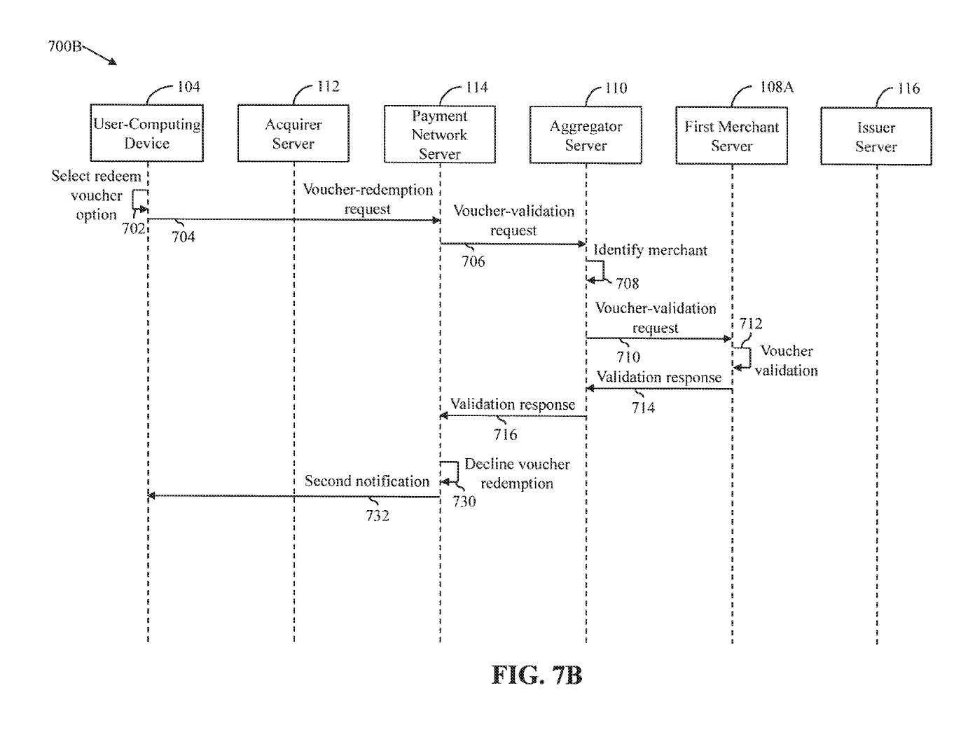

Referring now to FIGS. 7A and 7B, process flow diagrams 700A and 700B that illustrate exemplary scenarios for redeeming vouchers, in accordance with another embodiment of the present invention, are shown. The process flow diagrams 700A and 700B illustrate scenarios when the GUI 502 is presented on the user-computing device 104 by one of the application interface or the website hosted by the payment network server 114.

With reference to FIG. 7A, the process flow diagram 700A illustrates the user-computing device 104, the first merchant server 108A, the aggregator server 110, the acquirer server 112, the payment network server 114, and the issuer server 116. The user 102 accesses the application interface or the website hosted by the payment network server 114 using the user-computing device 104 for redeeming the voucher against the previous purchase made by her.

The application interface or the website presents the GUI 502 on the display of the user-computing device 104. The user 102 inputs the voucher ID of the voucher, the purchase order ID of the previous purchase, the account ID, and the merchant ID in the first through fourth input sections 504-510, respectively, and clicks on the redeem voucher tab 512 to select the redeem voucher option (depicted by arrow 702). The voucher-redemption request (depicted by arrow 704) is then initiated through the application interface or the website and is communicated to the payment network server 114 through the communication network 118. The first transceiver 206 receives the voucher-redemption request. The first voucher-redemption manager 214 generates the voucher-validation request (depicted by arrow 706) for validating the voucher and communicates it to the aggregator server 110.

The second transceiver 306 receives the voucher-validation request. The identification manager 310 identifies (depicted by arrow 708) that the first merchant had issued the voucher, based on the merchant ID. The second transceiver 306 thus routes the voucher-validation request (depicted by arrow 710) to the first merchant server 108A. In another embodiment, the first transceiver 206 communicates the voucher-validation request directly to the first merchant server 108A.

The third transceiver 406 receives the voucher-validation request. The validation manager 412 performs the validation (depicted by arrow 712) of the voucher, based on the voucher-validation request as described in conjunction with FIG. 6A. The process flow diagram 700A illustrates the scenario, when the voucher is valid. The second voucher-redemption manager 410 identifies the voucher amount of the voucher as described in conjunction with FIG. 6A. The second voucher-redemption manager 410 further generates the validation response (as described in FIG. 6A) to indicate the result of the validation. The third transceiver 406 communicates the validation response (depicted by arrow 714) to the aggregator server 110. The second transceiver 306 receives the validation response and transmits it (depicted by arrow 716) to the payment network server 114. In another embodiment, the third transceiver 406 directly communicates the validation response to the payment network server 114.

The first voucher-redemption manager 214 initiates the redemption (depicted by arrow 718) of the voucher based on the validation response and notifies the user 102 by way of the first notification (depicted by arrow 720) that the voucher is redeemed. For redeeming the voucher, the transaction manager 212 generates the credit notification and transmits it (depicted by arrow 722) to the issuer server 116. In one embodiment, the transaction manager 212 further generates the debit notification and transmits it (depicted by arrow 724) to the acquirer server 112. The issuer server 116 receives the credit notification and credits (depicted by arrow 726) the account of the user 102 with the voucher amount. The acquirer server 112 receives the debit notification and deducts (depicted by arrow 728) the voucher amount from the first merchant account. Hence, the voucher is redeemed against the previous purchase.

With reference to FIG. 7B, the process flow diagram 700B illustrates the scenario, when the voucher is invalid. The first transceiver 206 receives the validation response (depicted by arrow 716) indicating that the voucher is invalid. Thus, the first voucher-redemption manager 214 declines (depicted by arrow 730) the redemption of the voucher and notifies the user 102 by way of the second notification (depicted by arrow 732) that the voucher is invalid for redemption.

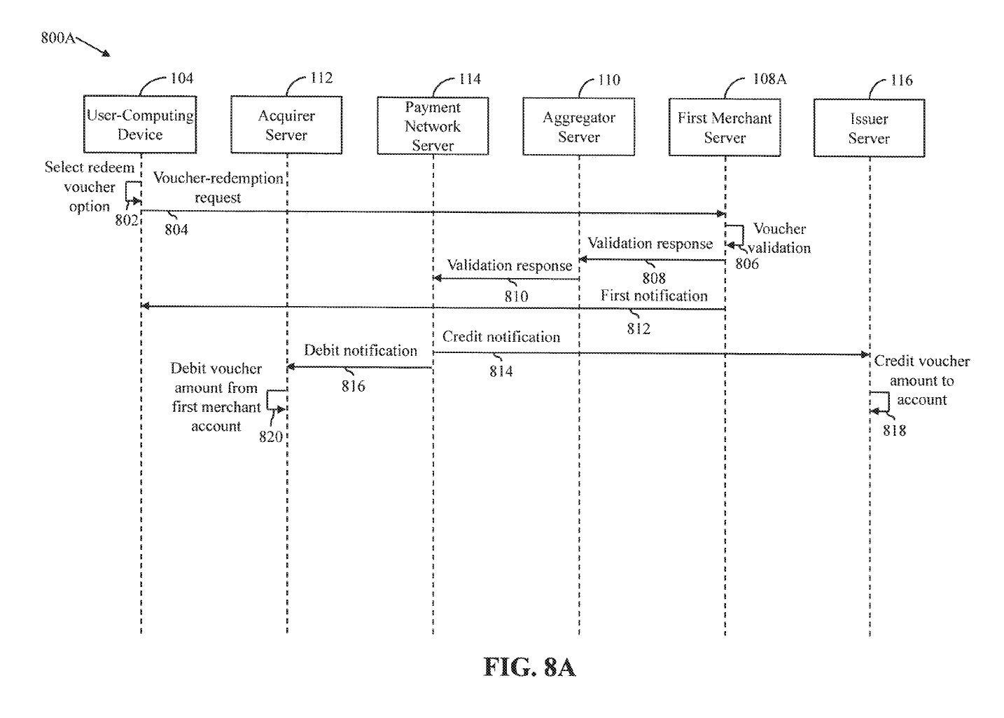

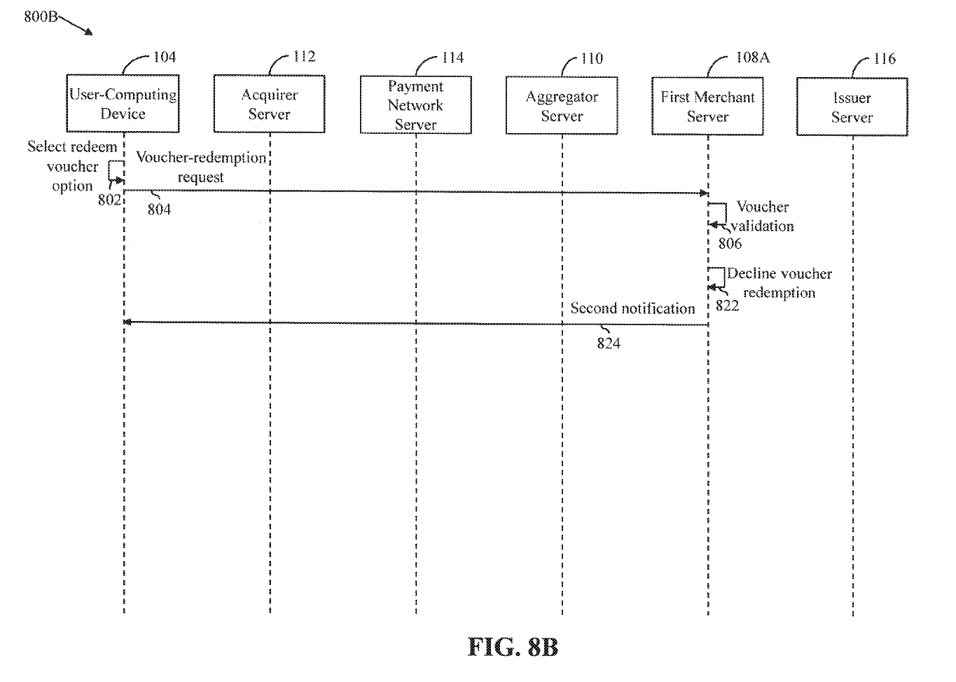

Referring now to FIGS. 8A and 8B, process flow diagrams 800A and 800B that illustrate exemplary scenarios for redeeming vouchers, in accordance with yet another embodiment of the present invention, are shown. The process flow diagrams 800A and 800B illustrate scenarios when the GUI 502 is presented on the user-computing device 104 by one of the application interface or the website hosted by the first merchant server 108A.

With reference to FIG. 8A, the process flow diagram 800A illustrates the user-computing device 104, the first merchant server 108A, the aggregator server 110, the acquirer server 112, the payment network server 114, and the issuer server 116. The user 102 accesses the application interface or the website through the user-computing device 104 for redeeming the voucher against the previous purchase made by her. The application interface or the website presents the GUI 502 to the user 102. The user 102 inputs the voucher ID, the purchase order ID of the previous purchase, and the account ID in the first through third input sections 504-508, respectively, and clicks on the redeem voucher tab 512 to select (depicted by arrow 802) the redeem voucher option. Thus, the voucher-redemption request (depicted by arrow 804) is initiated through the application interface or the website and is communicated to the first merchant server 108A through the communication network 118.

The third transceiver 406 receives the voucher-redemption request. The validation manager 412 performs the validation (depicted by arrow 806) of the voucher, based on the voucher-redemption request as described in the foregoing in conjunction with FIG. 6A. The process flow diagram 800A illustrates the scenario, when the voucher is valid. The second voucher-redemption manager 410 identifies the voucher amount of the voucher and generates the validation response as described in conjunction with FIG. 6A.

In one embodiment, the third transceiver 406 communicates the validation response (depicted by arrow 808) to the aggregator server 110. The second transceiver 306 receives the validation response and transmits it (depicted by arrow 810) to the payment network server 114. In another embodiment, the third transceiver 406 directly communicates the validation response to the payment network server 114. The second voucher-redemption manager 410 further notifies the user 102 by way of the first notification (depicted by arrow 812) that the voucher is redeemed. Based on the validation response, the transaction manager 212 generates the credit notification and the debit notification as described in conjunction with FIG. 6A. The first transceiver 206 transmits the credit and debit notifications (depicted by arrows 814 and 816, respectively) to the issuer and acquirer servers 116 and 112, respectively. The issuer server 116 receives the credit notification and credits (depicted by arrow 818) the account of the user 102 with the voucher amount. The acquirer server 112 receives the debit notification and deducts (depicted by arrow 820) the voucher amount from the first merchant account. The voucher stands redeemed when the account of the user 102 is credited with the voucher amount.

In another scenario, when the first merchant server 108A maintains the e-wallet of the user 102, the second voucher-redemption manager 410 requests the acquirer server 112 to debit the voucher amount from the first merchant account and credits the e-wallet with the voucher amount, without involving the payment network server 114. In yet another scenario, the first merchant server 108A may request the acquirer server 112 to debit the voucher amount from the first merchant account by way of at least one of the payment network server 114 and the aggregator server 110, and may credit the e-wallet with the voucher amount.

With reference to FIG. 8B, the process flow diagram 800B illustrates the scenario, when the voucher is invalid. The second voucher-redemption manager 410 declines (depicted by arrow 822) the voucher redemption when the voucher is invalid and notifies the user 102 by way of the second notification (depicted by arrow 824) that the voucher is invalid for redemption.

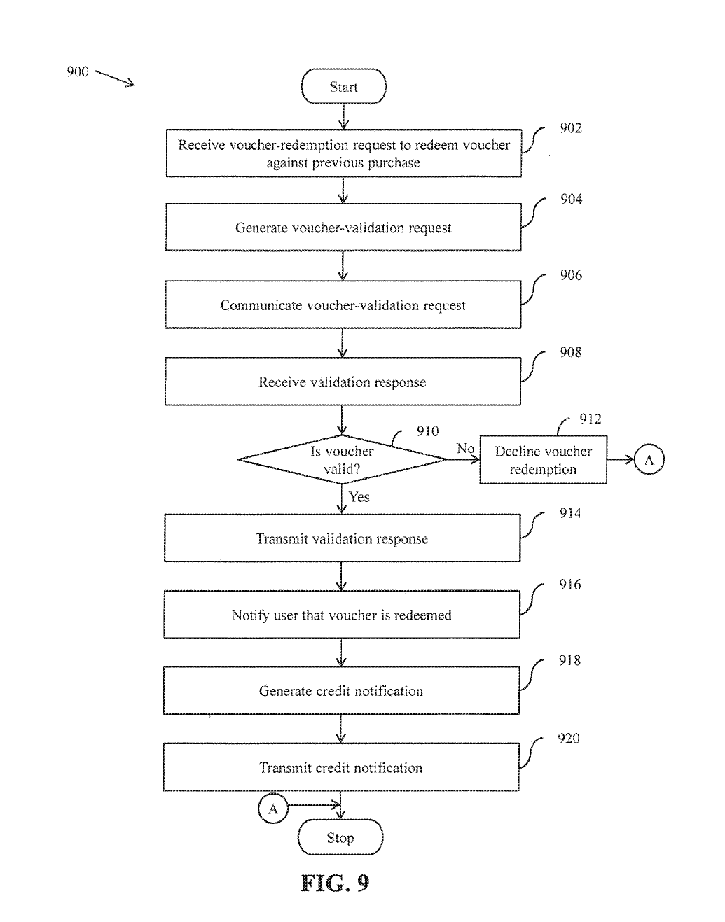

Referring now to FIG. 9, a flow chart 900 that illustrates the method for redeeming vouchers against previous purchases, in accordance with an embodiment of the present invention, is shown. The user 102 selects the voucher redemption option to redeem a voucher by accessing the application interface installed on the user-computing device 104 or the website. In one embodiment, the application interface or the website is presented to the user 102 by the payment network server 114. In another embodiment, the application interface or the website is presented to the user 102 by one of the first and second merchant servers 108A and 108B.

At step 902, the payment network server 114 receives the voucher-redemption request to redeem the voucher against the previous purchase made by the user 102. At step 904, the payment network server 114 generates the voucher-validation request for validation of the voucher. At step 906, the payment network server 114 communicates the voucher-validation request to a merchant server (i.e., one of the first and second merchant servers 108A and 108B) that corresponds to the voucher. In one embodiment, the payment network server 114 communicates the voucher-validation request by way of the aggregator server 110.

At step 908, the payment network server 114 receives the validation response from the merchant server (i.e., one of the first and second merchant servers 108A and 108B) that corresponds to the voucher. In one embodiment, the payment network server 114 receives the validation response by way of the aggregator server 110. The validation response indicates whether the voucher is valid or invalid. When the voucher is valid, the validation response includes the voucher amount associated with the voucher. At step 910, the payment network server 114 determines whether the voucher is valid based on the validation response. If at step 910, it is determined that the voucher is invalid, step 912 is performed. At step 912, the payment network server 114 declines the redemption of the voucher and notifies the user 102 by way of the second notification. If at step 910, it is determined that the voucher is valid, step 914 is performed. At step 914, the payment network server 114 transmits the validation response to the acquirer server 112. At step 916, the payment network server 114 notifies the user 102 by way of the first notification that voucher is redeemed. At step 918, the payment network server 114 generates the credit notification for crediting the voucher amount to the account specified by the user 102 in the voucher-redemption request. At step 920, the payment network server 114 transmits the credit notification to the issuer server 116 for crediting the voucher amount to the account. Based on the credit notification, the issuer server 116 credits the voucher amount to the account and the voucher is redeemed.

It will be apparent to a person skilled in the art that the scope of the invention is not limited to the payment network server 114 performing the above-mentioned steps. In another embodiment, the aggregator server 110 may perform the above-mentioned steps without departing from the spirit of the invention.

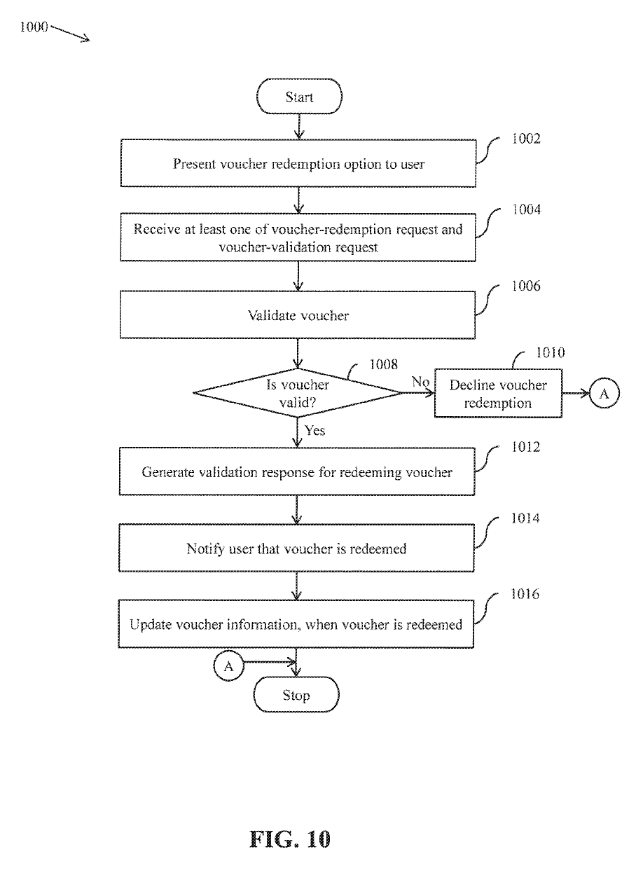

Referring now to FIG. 10, a flow chart 1000 that illustrates the method for redeeming vouchers against previous purchases, in accordance with another embodiment of the present invention, is shown. For the sake of simplicity, the flow chart 1000 is explained with respect to the first merchant server 108A. However, it will be apparent to a person skilled in the art that the second merchant server 108B may also perform the method of flow chart 1000.

At step 1002, the first merchant server 108A presents the voucher redemption option (as described in FIG. 5) to the user 102 by way of at least one of the application interface or the website. The user 102 may select the voucher redemption option to redeem a voucher against a previous purchase. At step 1004, the first merchant server 108A receives at least one of the voucher-redemption request (as described in FIG. 6A) and the voucher-validation request for redeeming the voucher against the previous purchase. At step 1006, the first merchant server 108A validates the voucher based on at least one of the voucher-redemption request and the voucher-validation request. At step 1008, the first merchant server 108A determines whether the voucher is valid or invalid based on the voucher ID and the purchase order ID included in at least one of the voucher-redemption request and the voucher-validation request. If at step 1008, it is determined that the voucher is invalid, step 1010 is performed. At step 1010, the first merchant server 108A declines the voucher redemption and notifies the user 102 by way of the second notification that the voucher is invalid for redemption. If at step 1008, it is determined that the voucher is valid, step 1012 is performed. At step 1012, the first merchant server 108A generates the validation response for redeeming the voucher. The validation response includes the voucher amount determined by the first merchant server 108A. In one embodiment, the first merchant server 108A communicates the validation response to the payment network server 114 for initiating the redemption of the voucher by transmitting the credit and debit notifications to the issuer and acquirer servers 116 and 112 (as described in FIG. 8A). In another embodiment, the first merchant server 108A requests the acquirer server 112 to debit the voucher amount from the first merchant account and credit it to the account of the user 102. In yet another embodiment, the first merchant server 108A requests the acquirer server 112 to debit the voucher amount from the first merchant account and further credits the voucher amount to the e-wallet of the user 102 maintained at the first merchant server 108A.

At step 1014, the first merchant server 108A notifies the user 102 that the voucher is redeemed. At step 1016, the first merchant server 108A further updates the voucher information of the voucher, when the voucher is redeemed. For example, the first merchant server 108A changes the status of the voucher from “active” to “inactive”, when the voucher is redeemed.

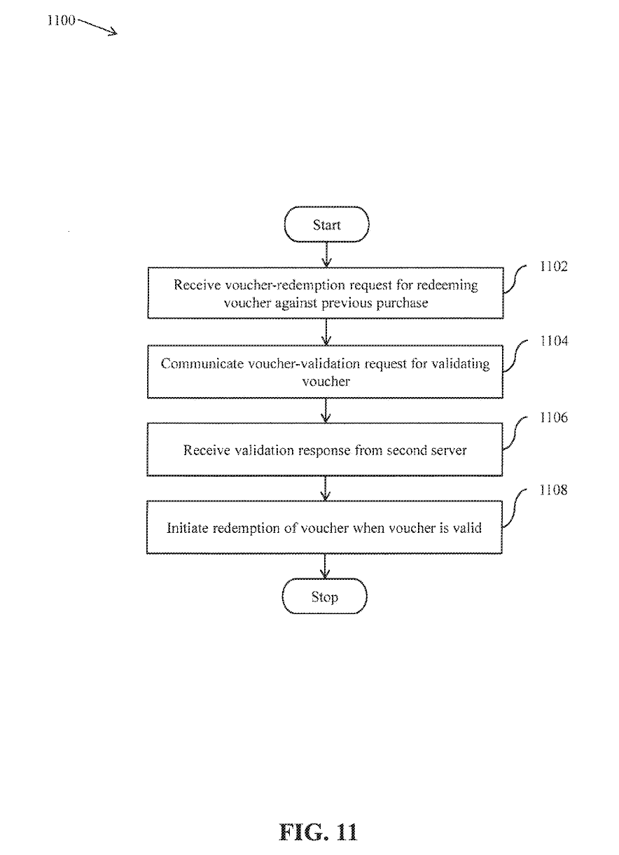

Referring now to FIG. 11, a high-level flow chart 1100 that illustrates the method for redeeming vouchers against previous purchases, in accordance with an embodiment of the present invention, is shown. The user 102 initiates the voucher-redemption request to redeem the voucher against the previous purchase made by the user 102. At step 1102, a first server (such as the payment network server 114 or the aggregator server 110) receives the voucher-redemption request for redeeming the voucher against the previous purchase. At step 1104, the first server (such as the payment network server 114 or the aggregator server 110) communicates the voucher-validation request (as described in FIG. 6A and FIG. 7A) for validating the voucher to a second server (i.e., one of the first and second merchant servers 108A and 108B) that corresponds to the voucher. At step 1106, the first server (such as the payment network server 114 or the aggregator server 110) receives the validation response from the second server (such as the first merchant server 108A or the second merchant server 108B). At step 1108, the first server (such as the payment network server 114 or the aggregator server 110) initiates the redemption of the voucher, when the voucher is valid. The first server (such as the payment network server 114 or the aggregator server 110) declines the redemption of the voucher, when the voucher is invalid. When the voucher is redeemed, the account of the user 102 specified in the voucher-validation request is credited with the voucher amount.

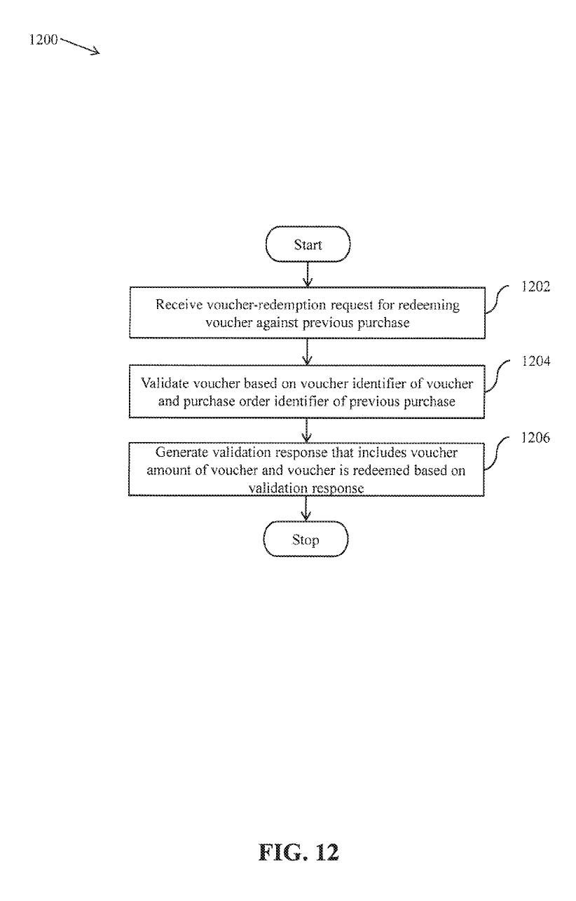

Referring now to FIG. 12, a high-level flow chart 1200 that illustrates the method for redeeming vouchers against previous purchases, in accordance with another embodiment of the present invention, is shown. The user 102 initiates the voucher-redemption request to redeem the voucher against the previous purchase made by the user 102. The user 102 accesses the application interface or the website hosted by a server (such as the first or second merchant server 108A or 108B) for raising the voucher-redemption request. At step 1202, the server (such as the first or second merchant server 108A or 108B) receives the voucher-redemption request for redeeming the voucher against the previous purchase. At step 1204, the server (such as the first or second merchant server 108A or 108B) validates the voucher based on the voucher ID of the voucher and the purchase order ID of the previous purchase. At step 1206, the server (such as the first or second merchant server 108A or 108B) generates the validation response that includes the voucher amount of the voucher, when the voucher is valid. The voucher is redeemed based on the validation response. When the voucher is redeemed, the account or e-wallet of the user 102 as specified in the voucher-redemption request is credited with the voucher amount. The server (such as the first or second merchant server 108A or 108B) declines the redemption of the voucher, when the voucher is invalid and notifies the user 102.

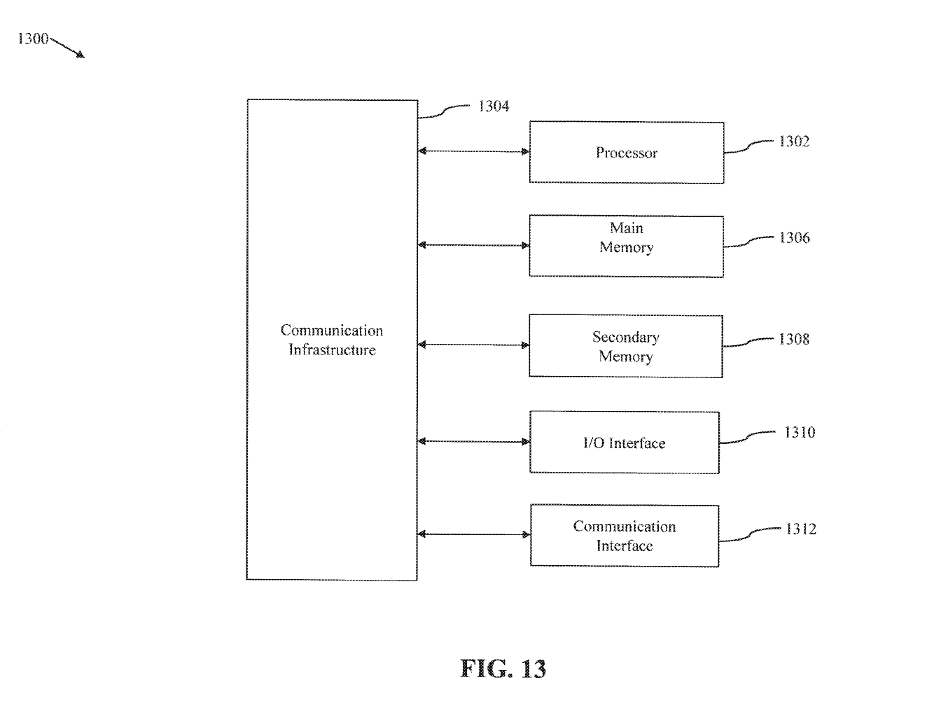

Referring now to FIG. 13, a block diagram that illustrates system architecture of a computer system 1300, in accordance with an embodiment of the present invention is shown. An embodiment of present invention, or portions thereof, may be implemented as computer readable code on the computer system 1300. In one example, the user-computing device 104, the merchant servers 108, the aggregator server 110, the acquirer server 112, the payment network server 114, and the issuer server 116 of FIG. 1 may be implemented in the computer system 1300 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIG. 9, FIG. 10, FIG. 11, and FIG. 12.

The computer system 1300 includes a processor 1302 that may be a special-purpose or a general-purpose processing device. The processor 1302 may be a single processor, multiple processors, or combinations thereof. The processor 1302 may have one or more processor cores. In one example, the processor 1302 is an octa-core processor. Further, the processor 1302 may be connected to a communication infrastructure 1304, such as a bus, i.e., the first, second, and third buses 208, 308, and 408, message queue, multi-core message-passing scheme, and the like. The computer system 1300 may further include a main memory 1306 and a secondary memory 1308. Examples of the main memory 1306 may include RAM, ROM, and the like. In one embodiment, the main memory 1306 is the first, second, and third memories 204, 304, and 404. The secondary memory 1308 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1300 further includes an input/output (I/O) interface 1310 and a communication interface 1312. The I/O interface 1310 includes various input and output devices that are configured to communicate with the processor 1302. Examples of the input devices may include a keyboard, a mouse, a joystick, a touchscreen, a microphone, and the like. Examples of the output devices may include a display screen, a speaker, headphones, and the like. The communications interface 1312 may be configured to allow data to be transferred between the computer system 1300 and various devices that are communicatively coupled to the computer system 1300. Examples of the communications interface 1312 may include a modem, a network interface, i.e., an Ethernet card, a communications port, and the like. Data transferred via the communications interface 1312 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 1300. Examples of the communications channel may include, but are not limited to, cable, fiber optics, a phone line, a cellular phone link, a radio frequency link, and the like.

Computer program medium and computer usable medium may refer to memories, such as the main memory 1306 and the secondary memory 1308, which may be a semiconductor memory such as a DRAM. These computer program mediums may provide data that enables the computer system 1300 to implement the methods illustrated in FIG. 9, FIG. 10, FIG. 11, and FIG. 12. In an embodiment, the present invention is implemented using a computer implemented application, the computer implemented application may be stored in a computer program product and loaded into the computer system 1300 using the removable storage drive or the hard disc drive in the secondary memory 1308, the I/O interface 1310, or communications interface 1312.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 1302 and a memory such as the main memory 1306 and the secondary memory 1308 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

The communication environment 100 enables the user 102 to redeem vouchers against previous purchases without any inconvenience. Hence, a voucher does not stand unused until a next purchase, if the user 102 had failed to redeem it during a previous purchase. By way of the communication environment 100, the user 102 no longer requires waiting for the next purchase and can redeem the voucher any time after the purchase also. In addition, the communication environment 100 ensures that only valid vouchers are redeemed, thereby preventing any monetary loss to the merchants as well.

Techniques consistent with the present invention provide, among other features, systems and methods for redeeming vouchers against previous purchases. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A voucher redemption method, comprising:
receiving, by a first server, a voucher-redemption request for redeeming a voucher against a previous purchase made by a user, wherein the voucher-redemption request includes a voucher identifier of the voucher, an account identifier of an account, and a purchase order identifier associated with the previous purchase;
communicating, by the first server, a voucher-validation request to a second server for validating the voucher, wherein the voucher is validated based on the voucher identifier and the purchase order identifier;
receiving, by the first server, a validation response from the second server based on the voucher-validation request, wherein the validation response includes a voucher amount associated with the voucher, when the voucher is valid; and
initiating, by the first server, a redemption of the voucher when the voucher is valid, whereby the account is credited with the voucher amount, when the voucher is redeemed.

2. The voucher redemption method of claim 1, further comprising presenting, by the first server, a voucher redemption option to the user by way of an application interface installed on a user-computing device of the user, wherein the voucher-redemption request is received when the user selects the voucher redemption option.

3. The voucher redemption method of claim 1, further comprising presenting, by the first server, a voucher redemption option to the user by way of a website that is accessed by the user, wherein the voucher-redemption request is received when the user selects the voucher redemption option.

4. The voucher redemption method of claim 1, further comprising declining, by the first server, the redemption of the voucher when the validation response indicates that the voucher is invalid.

5. The voucher redemption method of claim 1, further comprising notifying, by the first server, the user that the redemption of the voucher is initiated, when the validation response indicates that the voucher is valid.

6. The voucher redemption method of claim 1, further comprising identifying, by the first server, a merchant that provided the voucher to the user, based on the voucher-redemption request.

7. The voucher redemption method of claim 1, further comprising transmitting, by the first server, a credit notification to a third server to credit the account with the voucher amount for redeeming the voucher, when the voucher is valid.

8. The voucher redemption method of claim 1, wherein the voucher is validated based on one or more validation rules.

9. A voucher redemption system, comprising:
a payment network server, comprising:
a processor that is configured to:
receive a voucher-redemption request for redeeming a voucher against a previous purchase made by a user, wherein the voucher-redemption request includes a voucher identifier of the voucher, an account identifier of an account, and a purchase order identifier associated with the previous purchase;
communicate a voucher-validation request to a merchant server for validating the voucher, wherein the voucher is validated based on the voucher identifier and the purchase order identifier;
receive a validation response from the merchant server based on the voucher-validation request, wherein the validation response includes a voucher amount associated with the voucher, when the voucher is valid; and
initiate a redemption of the voucher, when the voucher is valid, whereby the account is credited with the voucher amount, when the voucher is redeemed.

10. The voucher redemption system of claim 9, wherein the processor is further configured to present a voucher redemption option to the user by way of an application interface installed on a user-computing device of the user, and wherein the voucher-redemption request is received when the user selects the voucher redemption option.

11. The voucher redemption system of claim 9, wherein the processor is further configured to present a voucher redemption option to the user by way of a website that is accessed by the user, and wherein the voucher-redemption request is received when the user selects the voucher redemption option.

12. The voucher redemption system of claim 9, wherein the processor is further configured to decline the redemption of the voucher when the validation response indicates that the voucher is invalid.

13. The voucher redemption system of claim 9, wherein the processor is further configured to notify the user that the redemption of the voucher is declined when the validation response indicates that the voucher is invalid.

14. The voucher redemption system of claim 9, wherein the processor is further configured to notify the user that the redemption of the voucher is initiated when the validation response indicates that the voucher is valid.

15. The voucher redemption system of claim 9, wherein the processor is further configured to transmit a credit notification to an issuer server to credit the account with the voucher amount for redeeming the voucher, when the voucher is valid.

16. A voucher redemption method, comprising:
receiving, by a merchant server, a voucher-redemption request for redeeming a voucher against a previous purchase made by a user, wherein the voucher-redemption request includes a voucher identifier of the voucher, an account identifier of an account, and a purchase order identifier associated with the previous purchase;
validating, by the merchant server, the voucher based on the voucher identifier and the purchase order identifier; and
generating, by the merchant server, a validation response that includes a voucher amount associated with the voucher when the voucher is valid, wherein the voucher is redeemed based on the validation response, and whereby the account is credited with the voucher amount, when the voucher is redeemed.

17. The voucher redemption method of claim 16, further comprising presenting, by the merchant server, a voucher redemption option to the user by way of at least one of an application interface installed on a user-computing device of the user and a website that is accessed by the user, wherein the voucher-redemption request is received when the user selects the voucher redemption option.

18. The voucher redemption method of claim 16, further comprising declining, by the merchant server, the redemption of the voucher when the voucher is invalid.

19. The voucher redemption method of claim 16, further comprising notifying, by the merchant server, the user that the redemption of the voucher is declined when the voucher is invalid.

20. The voucher redemption method of claim 16, further comprising:
retrieving, by the merchant server, voucher information of the voucher and purchase details of the previous purchase from a memory based on the voucher identifier and the purchase order identifier, respectively;
validating, by the merchant server, the voucher based on the voucher information, the purchase details, and one or more validation rules, wherein the one or more validation rules are stored in the memory, and wherein the voucher is redeemed, when the voucher is valid; and
notifying, by the merchant server, the user that the redemption of the voucher is successful, when the voucher is redeemed.
